(19) United States
(12) Patent Application Publication
(10) Pub. No.: US 2015/0003058 A1
(43) Pub. Date: Jan. 1, 2015

(54) LED LIGHT BULB

(71) Applicant: Biao ZHANG, Bellevue, WA (US)

(72) Inventor: Biao ZHANG, Bellevue, WA (US)

(21) Appl. No.: 14/321,410

(22) Filed: Jul. 1, 2014

Related U.S. Application Data
(60) Provisional application No. 61/841,463, filed on Jul. 1, 2013.

(51) Int. Cl. F21K 99/00; F21V 23/02; F21V 25/12

(52) U.S. Cl. CPC F21K 9/135; F21K 9/50; F21V 25/12; F21V 23/02; F21Y 2101/02
USPC 362/235; 362/249.02

(57) ABSTRACT

An improved LED light bulb apparatus mounted within existing incandescent bulb socket including at least two LED strip elements located inside an outer bulb shell and connected to a PCB made of glass fiber located inside an optional connecting piece. Each LED strip element extend upward and into the interior space formed in the outer bulb shell. Each LED strip element includes a straight or curved elongated body covered with colloidal silica with at least LED bulb mounted on its distal end. Two wire electrodes extend longitudinally on the body and connect at one end to the LED bulb and at an opposite end to the PCB or to an intermediate adapter that connects to the PCB. When more than one LED strip element is used, each element diverges into the interior space so the LED bulbs are at the same elevation and on opposite sides of the bulb's longitudinal axis.

### BACKGROUND OF THE INVENTION

This utility patent application is based on and claims the filing date benefit of U.S. Provisional patent application (Application No. 61/841,463) filed on Jul. 1, 2013.

### COPYRIGHT NOTICE

Notice is given that the following patent document contains original material subject to copyright protection. The copyright owner has no objection to the facsimile or digital download reproduction of all or part of the patent document, but otherwise reserves all copyrights.

1. Field of the Invention

This invention relates to LED light bulbs and more particularly to improved LED light bulbs identical in shape and size to a standard incandescent light bulbs and can be manufactured to produce different amounts of illumination with reduced heat product.

2. Description of the Related Art

There are several problems associated with currently available LED light bulbs. First, currently available LED light bulbs used glass bulb shells that have shapes and sizes than bulb shells used with incandescent light bulbs which is often noticeable and distractive. Second, the field or area of illumination from a LED light bulb often creates dark areas or shadows on nearly surfaces caused by the LEDs being positioned adjacent to the bulb's socket base. The socket base partially blocks light from the LED elements producing dark areas or shadows on the surface adjacent to the socket base. Third, LEDs and the printed circuit boards found in an LED light bulb produce heat which dissipated by a large visible heat sink.

What is needed is an improved LED light bulb that addresses these problems.

### SUMMARY OF THE INVENTION

An improved LED light bulb apparatus mounted within existing incandescent bulb socket including at least one elongated LED strip element located inside an outer bulb shell and connected to a PCB. The LED strip element extends upward from the socket base and into the central area of the bulb shell. Each LED strip element has a straight or curved elongated body covered with colloidal silica with at least one LED mounted on its distal end. Two wire electrodes extend longitudinally on the body and connect at one end to the LED bulb and at an opposite end to the PCB. When two or more strip element are used, they diverge from the socket base and into the interior space formed inside the outer bulb shell so the LEDs are approximately at the same elevation above the socket base and evenly distributed from the outer bulb shell's longitudinally axis.

In one embodiment, the PCB is made of glass fiber to reduce heat. Also, in another embodiment, an optional connecting piece is provided that covers the PCB and creates a reflective surface.

In one embodiment, a current supply is connected between the PCB and the socket base to convert an AC circuit into a DC circuit.

### DESCRIPTION OF THE DRAWINGS

FIG. 1 is an exploded, side elevational view of a first embodiment of the improved LED light bulb.

FIG. 2 is an exploded, side elevational view of a second embodiment of the improved LED light bulb.

FIG. 3 is an exploded, side elevational view of a third embodiment of the improved LED light bulb.

FIG. 4 is an exploded, side elevational view of a fourth embodiment of the improved LED light bulb.

### DESCRIPTION OF THE PREFERRED EMBODIMENT(S)

Referring to the accompanying Figs., there is four embodiments of an improved LED light bulb that address and overcome problems associated with existing LED light bulbs. Each embodiment of the light bulb denoted 10A, 10B, 10C, and 10D, respectively, includes a socket base 12, an printed circuit board (PCB) 20, an LED strip element 28, and an outer bulb shell 36.

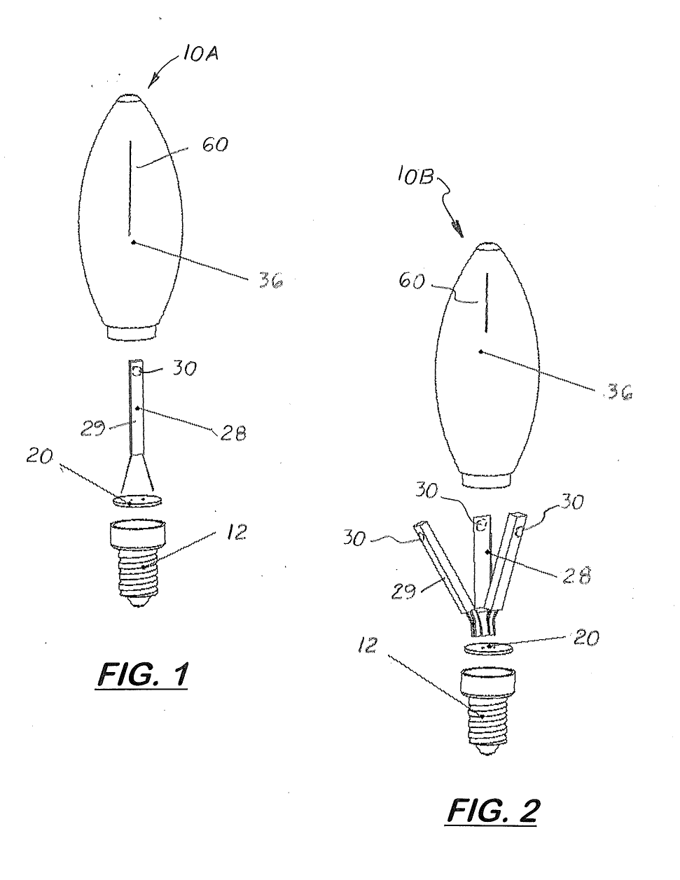

FIGS. 1 and 2 are exploded, side elevational view of a first and second embodiments of the improved LED light bulb 10A, 10B to be used with a DC power source. The PCB 20 is mounted inside the socket base 12, the LED strip element 28 is connected to the PCB 20, and the outer bulb shell 36 is connected to the socket base 12. Mounted on the LED strip element 28 is at least one LED 30.

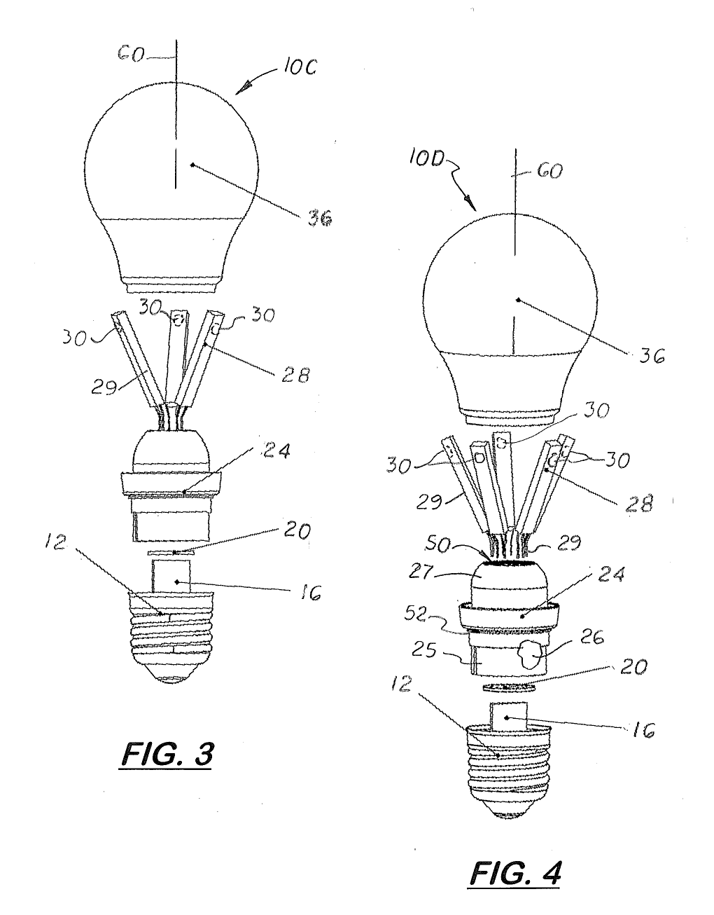

FIGS. 3 and 4 are exploded, side elevational views of a third and fourth embodiments of the improved LED light bulb, denoted 10C and 10D, respectively, to be used with an AC power source. Bulbs 10C and 10D include a socket base 12, a current supply device 16, and a connecting piece 24. The current supply device 16 converts an AC circuit into a DC circuit. The connecting piece 24 includes a lower neck with a hollow space in which the current supply device 16 and the PCB 20 are placed. The connecting piece 24 also includes an upper dome reflector surface 27 which acts as an inverse arc that scatters light. A hole 50 is formed on the connecting piece 24 through which wires 29 from the LED strip element extends 28 and connects to the PCB 20.

To avoid accidents caused by the electricity leakage, optional fittings 52 made of insulated flame retardant plastics may be used around the connecting piece 24. In the preferred embodiment, the dome reflective surface of the connecting piece 25 is white.

The PCB 20 is made of glass fiber that has high mechanical properties and high dielectric properties with heat resistance and moisture resistance properties

The outer bulb shell 30 is made of glass and is transparent or opaque.

The LED strip element 28 includes an thin rectangular shaped body 29 made of glass substrate covered by a layer of phosphor mixed with colloidal silica. An LED chip 30 is mounted on the distal end of the body 29. During operation, the glass substrate is slowly heated which reduces its overall working temperature. The mixture layer of phosphor and colloidal silica may contain different amounts of phosphor that produces different colors of light. When phosphor is used, the light emitted is white light.

The first embodiment shown in FIG. 1, the LED light bulb uses one LED strip element 28 longitudinally aligned with the socket base 12. The LED strip element 28 is sufficient in length so the LED 30 is disposed centrally inside the outer bulb shell 36. In the second and third embodiment, shown in FIGS. 2 and 3, the bulbs 10B, 10C each use three LED strip elements 28 each containing one LED bulb 30. In a fourth embodiment in FIG. 4, the bulb 10D uses five LED strip elements 28 each containing one LED 30. When a plurality of LED strip elements are seen in bulbs 10B, 10C, and 10D, the LED strip elements 28 bend or flare outward so the LED 30 are evenly spaced apart and elevated along the outer shell's central axis 60 and near the shell's inside surface. Because the LED 30 are located laterally to the bulb's central axis 60, emitted light from each LED 30 is transmitted over the sides of the socket base 12 reducing the dark or shadow areas on an adjacent surface. In order to meet the requirements of general lighting, socket base 12 is a model E14 or model E27 type socket other types of sockets may be used.

In compliance with the statute, the invention described has been described in language more or less specific as to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted under the doctrine of equivalents.

I claim:

1. An LED bulb lamp, comprising;
a. a socket connector;
b. a outer bulb shell connected to said socket connector;
c. a printed circuit board mounted inside said outer bulb shell; and,
d. at least one an elongated LED strip longitudinally aligned inside said outer bulb shell, said LED strip includes a LED chip on one end.

2. The LED bulb, as recited in claim 1, wherein said LED strip includes a glass substrate with an outer layer of colloidal silica mixed with phosphor.

3. The LED bulb as recited in claim 1, further including at least two LED strips located inside said outer shell, said LED strips bent or flare outward positioning said LED chip lateral to the bulb's longitudinal center axis.

4. The LED bulb as recited in claim 1 further including a connection piece located over said PCB, said connection piece includes a reflector that is an inverse arc and protruding to one side of the bulb shell and includes a hole that allow wires from said LED strip to extend and connect to said PCB.

5. The LED bulb as recited in claim 4, wherein said connection piece is made of insulating flame-retardant plastic.

6. The LED bulb, as recited in claim 1, wherein said reflector is white.

7. The LED bulb as recited in Clams 1-3 further including a current supply device (2) that converts AC into DC.

8. The LED bulb, as recited in claim 7, wherein said current supply device is located inside said connecting piece.

9. The LED bulb as recited in claims 1-3 wherein said PCB is made of glass fiber.
